(19) United States
(12) Patent Application Publication
(10) Pub. No.: US 2017/0074697 A1
(43) Pub. Date: Mar. 16, 2017

(54) CAPACITIVE AIRFOIL-BASED FLUID FLOW SENSOR

(71) Applicant: ANALOG DEVICES, INC., Norwood, MA (US)

(72) Inventor: Steven W. Ranta, Seattle, WA (US)

(73) Assignee: ANALOG DEVICES, INC., Norwood, MA (US)

(21) Appl. No.: 14/855,454

(22) Filed: Sep. 16, 2015

(51) Int. Cl. G01F 1/56; G01F 1/68

(52) U.S. Cl. CPC G01F 1/56; G01F 1/68

(57) ABSTRACT

A capacitive fluid flow sensor and methods for measuring fluid flow are disclosed herein. An exemplary capacitive fluid flow sensor includes an airfoil having a flexible surface, and a capacitive sensor disposed within the airfoil. A capacitance of the capacitive sensor modulates as the flexible surface deflects in response to fluid flow. The fluid flow sensor may be secured within a cooled equipment enclosure, where the flexible surface of the airfoil deflects in response to fluid flow, such as airflow, within the cooled equipment enclosure.

### TECHNICAL FIELD

The present disclosure relates generally to sensors, and more particularly, to fluid flow sensors.

### BACKGROUND

Fluid flow sensors can measure a rate of a fluid flow in various applications. For example, an electronics environment, which includes electronic equipment and/or electronic components that generate significant heat, implements a thermal management system having an airflow sensor that can measure airflow associated with the electronics environment. Although existing airflow sensors have been generally adequate for their intended purposes, they have not been entirely satisfactory in all respects.

### BRIEF DESCRIPTION OF DRAWINGS

The present disclosure is best understood from the following detailed description when read with the accompanying figures. It is emphasized that, in accordance with the standard practice in the industry, various features are not drawn to scale and are used for illustration purposes only. In fact, the dimension of the various features may be arbitrarily increased or reduced for clarity of discussion.

FIG. 1 is a simplified perspective view of an exemplary capacitive fluid flow sensor according to various aspects of the present disclosure.

FIG. 2 is a simplified cross-sectional view of the exemplary capacitive fluid flow sensor taken along line A-A in FIG. 1 according to various aspects of the present disclosure.

FIG. 3 is a simplified block diagram of an exemplary capacitive sensor, which can be implemented by the capacitive fluid flow sensor in FIG. 1 and FIG. 2, according to various aspects of the present disclosure.

FIG. 4 is a simplified block diagram of an exemplary thermally managed system, which can implement the capacitive fluid flow sensor in FIG. 1 and FIG. 2, according to various aspects of the present disclosure.

FIG. 5 is a flowchart of an exemplary method for measuring fluid flow, which can be implemented by the capacitive fluid flow sensor in FIG. 1 and FIG. 2, according to various aspects of the present disclosure.

### OVERVIEW OF EXAMPLE EMBODIMENTS

A capacitive fluid flow sensor and method for measuring fluid flow are disclosed herein that facilitate fluid flow measurements in locations not previously practical due to size, cost, and/or power. An exemplary capacitive fluid flow sensor includes an airfoil having a flexible surface, and a capacitive sensor disposed within the airfoil. A capacitance of the capacitive sensor modulates as the flexible surface deflects in response to airflow. In some implementations, the airfoil includes a living hinge from which the flexible surface extends. The capacitive fluid flow sensor may be secured within a cooled equipment enclosure (for example, a rack server) in a path of airflow, such that the flexible surface of the airfoil deflects in response to airflow within the cooled equipment enclosure. The capacitive fluid flow sensor may further include a temperature sensor affixed to the airfoil, where the temperature sensor measures a temperature of the fluid flow.

The capacitive sensor includes a capacitor and circuitry for measuring capacitance of the capacitor. The capacitor may include a movable conductive plate and a fixed conductive plate separated by a dielectric gap (for example, air). Displacement of the movable conductive plate moves corresponds with deflection of the flexible surface. In some implementations, the movable conductive plate is affixed to the flexible surface, and the fixed conductive plate is affixed to a rigid surface of the airfoil. In various implementations, a printed circuit board is disposed within a cavity of the airfoil. The printed circuit board includes circuitry for measuring a capacitance between the movable conductive plate and the fixed conductive plate. In some implementations, the printed circuit board serves as the rigid surface, where the fixed conductive plate is affixed to the printed circuit board. In some implementations, the fixed conductive plate is a conductive portion of the printed circuit board. In some implementations, the movable conductive plate is a conductive portion of the flexible surface.

### DETAILED DESCRIPTION OF EXAMPLE EMBODIMENTS

The present disclosure provides a capacitive fluid flow sensor for monitoring a thermal environment (for example, in a cooled equipment enclosure) that facilitates fluid flow measurements in locations not previously practical due to size, cost, and/or power. The capacitive fluid flow sensor includes a flexible surface configured to deflect in response to fluid flow in a manner that causes a capacitance change, which can be correlated to a rate of fluid flow. Although embodiments of capacitive fluid flow sensor are described herein with reference to airflow applications, the capacitive fluid flow sensor disclosed herein can be readily implemented to measure any fluid flow.

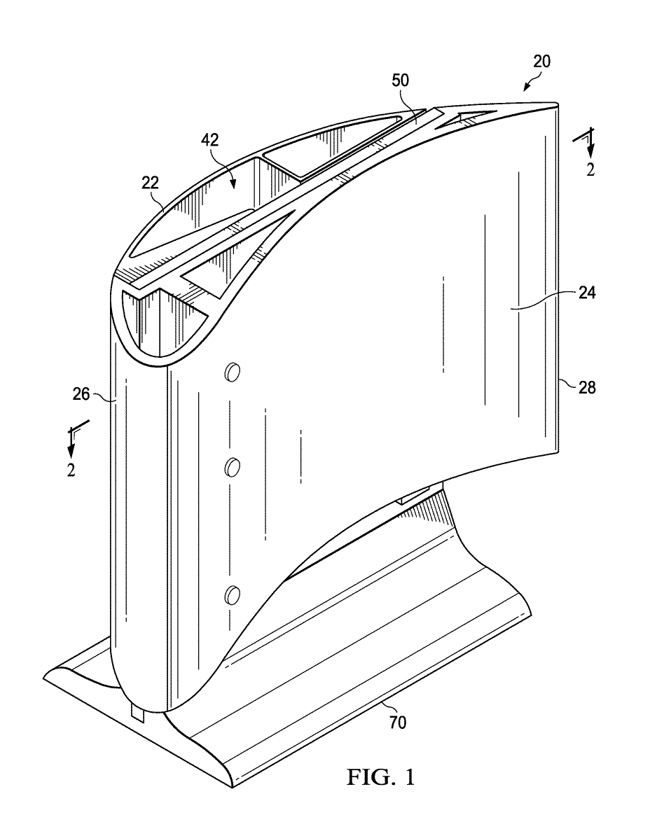

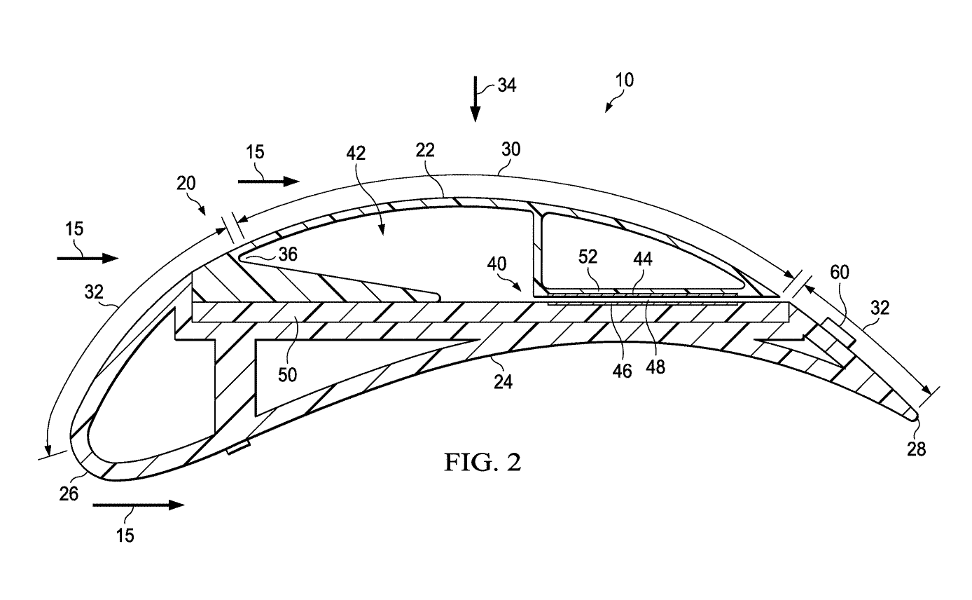

FIG. 1 is a simplified perspective view of an exemplary capacitive fluid flow sensor 10 for monitoring a thermal environment according to various aspects of the present disclosure, and FIG. 2 is a simplified cross-sectional view of the exemplary capacitive fluid flow sensor 10 taken along line A-A in FIG. 1 according to various aspects of the present disclosure. Capacitive fluid flow sensor 10 is positioned proximate to (for example, in a path of) fluid flow 15, such that capacitive fluid flow sensor 10 can monitor fluid flow 15 and/or fluid temperature. In various implementations described herein, capacitive fluid flow sensor 10 is an airflow sensor configured to monitor and measure airflow and/or air temperature, for example, in an electronics environment. For ease of discussion, FIG. 1 and FIG. 2 will be described concurrently. FIG. 1 and FIG. 2 have been simplified for the sake of clarity to better understand the inventive concepts of the present disclosure. Additional features can be added in capacitive fluid flow sensor 10, and some of the features described can be replaced, modified, or eliminated in other embodiments of capacitive fluid flow sensor 10.

In FIG. 1 and FIG. 2, capacitive fluid flow sensor 10 includes an airfoil 20 having an upper surface 22 and a lower surface 24 that extend between a leading edge 26 and a trailing edge 28. According to fluid dynamic principles (such as Bernoulli's principle), fluid flow 15 by airfoil 20 from leading edge 26 to trailing edge 28 will exert force on airfoil 20. In particular, fluid flow 15 above upper surface 22 from leading edge 26 to trailing edge 28 travels faster than fluid flow 15 below lower surface 24, causing a pressure differential of fluid flow 15 between upper surface 22 and lower surface 24. Fluid flow 15 typically exerts a lower pressure on upper surface 22 than lower surface 24. Such phenomenon generates lift, a component of force exerted by fluid flow 15 on airfoil 20 that is perpendicular to a direction of fluid flow 15. The various pressures exerted by fluid flow 15 on airfoil 20, along with the pressure differential between upper surface 22 and lower surface 24, change proportionally to increases or decreases in fluid flow 15.

Airfoil 20 is configured to deflect in response to airflow 15. For example, airfoil 20 is configured with one or more flexible portions that deflect in response to forces exerted thereon by pressure variances along airfoil 20 caused by fluid flow 15. The flexible portions may be a portion or entirety of upper surface 22 and/or lower surface 24. In the depicted embodiment, upper surface 22 includes a flexible portion 30 (referred to herein as flexible surface 30) and a rigid portion 32 (referred to herein as rigid surface 32). Flexible surface 30 deflects in response to pressure 34 exerted thereon by fluid flow 15. In furtherance of the depicted embodiment, lower surface 24 is rigid, though the present disclosure contemplates configurations of capacitive fluid flow sensor 10 where lower surface 24 includes flexibility. Flexible surface 30 extends from a living hinge 36 of airfoil 20. Living hinge 36 is a point of airfoil 20 from which upper surface 22 will naturally deflect when forces are applied thereto. For purposes of the present disclosure, the term “living hinge” generally refers to a flexible hinge (flexure bearing) joining portions of airfoil 20, as opposed to a mechanical hinge. As pressure 34 builds on upper surface 22, flexible surface 30 deflects (or bends) along living hinge 36 in response, in various implementations, towards lower surface 24 from living hinge 36.

A capacitive sensor 40, disposed in a cavity 42 of airfoil 20, measures displacement of flexible surface 30 in response to fluid flow 15, allowing airflow sensor 10 to deduce a rate of fluid flow 15. For example, capacitive sensor 40 detects a capacitance change when flexible surface 30 deflects in response to fluid flow 15. Capacitive sensor 40 includes a capacitor having a movable conductive plate and a fixed conductive plate, where displacement of the movable conductive plate corresponds with deflection of flexible surface 30 in response to fluid flow 15. In the depicted embodiment, a capacitor includes a conductive plate 44 separated from a conductive plate 46 by a dielectric gap 48. In various implementations, dielectric gap 48 is a fluid monitored by capacitive fluid flow sensor 10. For example, where capacitive fluid flow sensor 10 monitors airflow, dielectric gap 48 is air. Conductive plate 44 may be galvanically isolated from conductive plate 46. Conductive plate 44 is affixed to a flexible portion of capacitive fluid flow sensor 10, such as flexible surface 30, so that displacement of conductive plate 44 corresponds with deflection of the flexible portion in response to fluid flow 15. Conductive plate 46 is affixed to a rigid portion of capacitive fluid flow sensor 10, such as lower surface 24. Dielectric gap 48 between conductive plate 44 and conductive plate 46 narrows or widens depending on pressure exerted on flexible surface 30 by fluid flow 15.

Capacitive sensor 40 further includes circuitry for measuring any change in capacitance of the capacitor resulting from deflection of flexible surface 30. For example, a printed circuit board (PCB) 50 includes circuitry for measuring any change in capacitance between conductive plate 44 and conductive plate 46. In the depicted embodiment, PCB 50 is disposed within cavity 42 affixed to lower surface 42, and conductive plate 46 is affixed to PCB 50. In some implementations, conductive plate 44 may be a conductive portion of flexible surface 30, and conductive plate 46 may be a conductive portion (such as copper, carbon, or silver) of PCB 50. In some implementations, conductive plate 44, conductive plate 46, and dielectric gap 48 are arranged to form a parallel-plate capacitor. For example, flexible surface 30 may include a portion 52 that extends into cavity 42 parallel to PCB 50, such that conductive plate 44 may be affixed to portion 52 in parallel with conductive plate 46. In some implementations, portion 52 may be a conductive portion of flexible surface 30. In some implementations, a capacitor (two fixed conductive plates separated by a dielectric gap) resides on PCB 50, and flexible surface 30 includes a conductive portion (or includes a conductive plate affixed thereto) that serves as a third, movable conductive plate capacitively coupled with the capacitor and electrically coupled with PCB 50. In such implementations, as flexible surface 30 deflects in response to fluid flow 15, the third conductive plate varies a capacitance of the capacitor residing on PCB 50, which can be used to deduce fluid flow 15.

Flexible surface 30 modulates a capacitance of capacitive sensor 40 as flexible surface 30 deflects in response to fluid flow 15. For example, as pressure exerted by fluid flow 15 varies on flexible surface 30, flexible surface 30 deflects in response, altering a spacing (here, dielectric gap 48) between conductive plate 44 and conductive plate 46 and causing a change in capacitance between conductive plate 44 and conductive plate 46. As pressure exerted by fluid flow 15 on upper surface 22 increases, flexible surface 30 deflects towards lower surface 24, and conductive plate 44 moves closer to conductive plate 46, reducing spacing between conductive plate 44 and conductive plate 46. A capacitance between conductive plate 44 and conductive plate 46 can increase or decrease depending on various design parameters and/or requirements for capacitive fluid flow sensor 10. Accordingly, since capacitance changes correspond with displacement of flexible surface 30 in response to fluid flow 15, capacitive fluid flow sensor 10 can determine fluid flow parameters associated with fluid flow 15, such as a rate of fluid flow 15, from the capacitance changes detected by capacitive sensor 40.

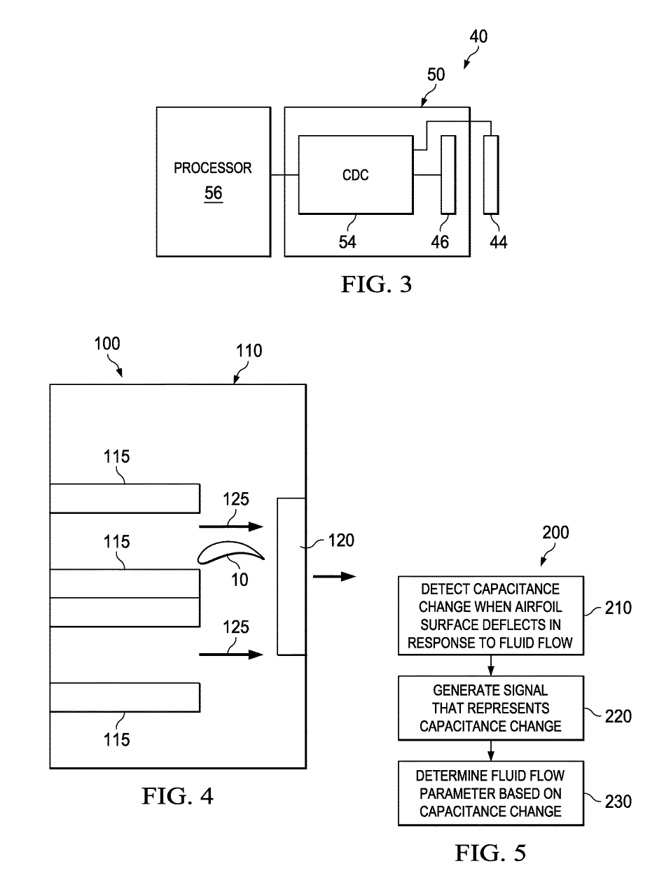

FIG. 3 is a simplified block diagram of an exemplary capacitive sensor, such as capacitive sensor 40, according to various aspects of the present disclosure. FIG. 3 depicts capacitive sensor 40 having a capacitor (for example, conductive plate 44 and conductive plate 46) and PCB 50, which includes a capacitance-to-digital converter (CDC) 54 electrically coupled with conductive plate 44 and conductive plate 46. CDC 54 measures capacitance between conductive plate 44 and conductive plate 46. In operation, CDC 54 converts a capacitive input signal representing a capacitance between conductive plate 44 and conductive plate 46 into a digital signal. In various implementations, CDC 54 is a capacitance-to-digital converter provided by Analog Devices Inc., such as Analog Devices' AD7156 ultralow power capacitance converter. The measured capacitance may be compared with a defined threshold (fixed or dynamically adjustable). A processor 56 can receive digital signals representing sensed capacitance and determine various fluid flow parameters, such as a speed and/or direction of fluid flow 15, based on the sensed capacitances. For example, since deflection of flexible surface 30 is proportional to a pressure or force exerted by fluid flow 15 on airfoil 20, and any capacitance change corresponds with deflection of flexible surface 30, a rate of fluid flow 15 is proportional to a measurable change in capacitance resulting from deflection of flexible surface 30. Any impurities in the fluid (for example, where the fluid forms dielectric gap 48 of capacitive sensor 40) may be minimized and/or compensated for by averaging signals representing capacitance detected by capacitive fluid flow sensor 10. In the depicted embodiment, a rate of fluid flow 15 increases as a capacitance between conductive plate 44 and conductive plate 46 increases. Alternatively, capacitive fluid flow sensor 10 may be designed, such that a rate of fluid flow 15 decreases as a capacitance between conductive plate 44 and conductive plate 46 increases. FIG. 3 has been simplified for the sake of clarity to better understand the inventive concepts of the present disclosure. Additional features can be added in capacitive sensor 40, and some of the features described can be replaced, modified, or eliminated in other embodiments of capacitive sensor 40.

Returning to FIG. 1 and FIG. 2, capacitive fluid flow sensor 10 further includes a temperature sensor 60. In the depicted embodiment, temperature sensor 60 is affixed to a surface of airfoil 20, such as upper surface 22, where temperature sensor 60 can measure a temperature of fluid flow 15. Alternatively, temperature sensor 60 may be disposed in cavity 42, where temperature sensor 60 measures a temperature of fluid, such as air, within cavity 42. Temperature sensor 60 may be coupled with circuitry of PCB 50 and/or processor 56. In some implementations, temperature sensor 60 may reside on PCB 50.

In the depicted embodiment, since flexible surface 30 deflects from living hinge 36 at an angle towards lower surface 24, instead of in parallel, capacitive sensor 40 will generate a non-linear capacitance response. Alternatively, the movable and/or fixed conductive plate(s) of capacitive sensor 40 may be configured to provide a linear response. For example, in some implementations, conductive plate 44 may be wedge-shaped so that portions of conductive plate 44 move relative to conductive plate 46 in a parallel manner. In various implementations, capacitive sensor 40 may be calibrated to establish a normal capacitance range.

The foregoing configurations are merely examples, and the present disclosure contemplates configuring capacitive fluid flow sensor 10 in any manner that achieves a surface that deflects in response to airflow 15 in a manner that causes a capacitance change, which can be correlated to fluid flow parameters as described herein. Airfoil 20 can have any suitable airfoil shape. In various embodiments, a shape of airfoil 20 as depicted can maximize sensitivity to changes in fluid flow 15, and particularly, maximize deflection of flexible portions, such as flexible surface 30. In various embodiments, a shape of airfoil 20 may be configured to maximize signal-to-noise ratios and/or sensitivity to fluid flow 15. The present disclosure further contemplates capacitive fluid flow sensor 10 having other shapes, other than airfoil shapes, so long as capacitive fluid flow sensor 10 is configured in a manner that can disrupt fluid flow 15 sufficiently to generate physical displacement of a flexible surface that registers as a change in capacitance. For example, in various implementations, capacitive fluid flow sensor 10 may be wedge-shaped, cylindrically-shaped, a thin laminar strip, and/or otherwise suitably-shaped to disrupt fluid flow 15 that can generate displacement of a flexible surface in a manner that varies a capacitance input signal.

Most fluid flow sensing solutions require significant space, complexity (for example, significant circuitry), and/or expense to implement. In contrast, capacitive fluid flow sensor 10 provides a very low cost mechanical arrangement, allowing fluid flow measurements in locations where not previously practical due to size, cost, and/or power. To minimize cost and/or complexity, low-cost materials may be implemented to manufacture capacitive fluid flow sensor 10. For example, in various implementations, capacitive fluid flow sensor 10 is formed by extruding a single piece of plastic into an airfoil (such as airfoil 20) with a cavity (such as cavity 42) for insertion of a capacitive sensor (such as capacitive sensor 40). The plastic may be thinned (or cut) at various locations to form a living hinge (such as living hinge 36) that joins a rigid portion (such as rigid surface 32) and a flexible portion (such as flexible surface 30), where the flexible portion moves relative to the living hinge in response to pressure exerted on the flexible portion by fluid flow. The living hinge may be accomplished by a natural bend point in the continuous piece of plastic, though the present disclosure contemplates fluid flow sensor embodiments formed using various materials. The plastic may be any suitable plastic material. Furthermore, since a circuit board (such as PCB 50) can be used to provide the capacitor and circuitry for measuring a capacitance of the capacitor, capacitive fluid flow sensor 10 is designed with simplicity, robustness, and very low power considerations.

Capacitive fluid flow sensor 10 can be utilized by a thermal management system for monitoring thermal characteristics, such as an airflow and/or air temperature of the airflow, in an electronics environment. Such electronics environment often includes electronic equipment and/or electronic components that generate significant heat. For example, capacitive fluid flow sensor 10 can measure airflow in a cooled equipment enclosure for housing electronics, spanning minimal space within the cooled equipment enclosure. FIG. 4 is a simplified block diagram of an exemplary thermally managed system 100, which can implement a fluid flow sensor, according to various aspects of the present disclosure. In FIG. 4, thermally managed system 100 includes an equipment enclosure 110 that houses various electronic components 115. Thermally managed system 100 may be a server rack, where equipment enclosure 110 is a rack that supports various rack-mounted electronic components 115. A cooling system 120 can facilitate airflow 125 within equipment enclosure 110, which can protect electronic components 115 from damage that may result from heat generated by electronic components 115 and/or other components within equipment enclosure 110. For example, cooling system 120 may include a fan that provides air to or removes air from equipment enclosure 110. In the depicted embodiment, capacitive fluid flow sensor 10 is secured within equipment enclosure 110 in a path of airflow 125, such that capacitive fluid flow sensor 10 can monitor airflow 125 and/or temperature of airflow 125 for anomalies and/or predictive maintenance. In some implementations, capacitive fluid flow sensor 10 can predict when an air filter within thermally managed system 100 needs to be changed and/or cleaned. In some implementations, capacitive fluid flow sensor 10 can detect when airflow 125 is abnormally low and/or abnormally high. In some implementations, capacitive fluid flow sensor 10 can detect when a temperature of airflow 125 is abnormally high and/or abnormally low. Though the present disclosure contemplates capacitive fluid flow sensor 10 with any size, in various implementations, capacitive fluid flow sensor 10 has a depth of about 1 inch and a length and width of about 2 inches to about 3 inches. FIG. 4 has been simplified for the sake of clarity to better understand the inventive concepts of the present disclosure. Additional features can be added in thermally managed system 100, and some of the features described can be replaced, modified, or eliminated in other embodiments of thermally managed system 100.

FIG. 5 is a flowchart of an exemplary method 200 for measuring fluid flow that can be implemented by a fluid flow sensor, such as fluid flow sensor 10 described and illustrated in FIGS. 1-3, according to various aspects of the present disclosure. At block 210, a capacitance change is detected when an airfoil surface deflects in response to fluid flow, such as airflow. In various implementations, airfoil surface is configured to deflect in proportion to a pressure exerted on airfoil surface by the fluid flow. At block 220, a signal is generated that represents the capacitance change. At block 230, a fluid flow parameter, such as a rate of fluid flow, is determined based on the capacitance change. In various implementations, the rate of fluid flow correlates with displacement (deflection) of the airfoil surface, and the capacitance change correlates with displacement deflection of the airfoil surface. The rate of fluid flow can thus be determined based on the capacitance change. In various implementations, an alarm may be generated when the fluid flow parameter meets, exceeds, or falls below a fluid flow threshold. For example, in a cooled equipment enclosure where the fluid flow sensor monitors airflow within the cooled equipment enclosure, an alarm may be generated when the fluid flow parameter indicates that a rate of airflow is abnormally low, indicating that airflow is insufficient in cooled equipment enclosure. In another example, in a cooled equipment enclosure where the fluid flow sensor monitors airflow within the cooled equipment enclosure, an alarm may be generated when the fluid flow parameter meets an airflow threshold indicating that an air filter associated with cooled equipment enclosure needs changing and/or cleaning In some implementations, method 200 further includes sensing a temperature of the fluid flow and generating a signal that represents the temperature. An alarm may be generated when the temperature meets, exceeds, or falls below a temperature threshold. FIG. 5 has been simplified for the sake of clarity to better understand the inventive concepts of the present disclosure. Additional steps can be added in the method 200, and some of the steps described herein can be replaced or eliminated in other embodiments of the method 200.

In various implementations, the various functions (such as the sensing, detecting, generating, determining, signaling, and other functions) outlined herein may be implemented by logic encoded in one or more non-transitory and/or tangible media (for example, e.g., embedded logic provided in an application specific integrated circuit (ASIC), as digital signal processor (DSP) instructions, software (potentially inclusive of object code and source code) to be executed by a processor, or other similar machine, etc.). In some of these instances, a memory element can store data used for the operations described herein. This includes the memory element being able to store logic (for example, software, code, processor instructions) that is executed by a processor to carry out the activities described herein. The processor can execute any type of instructions associated with the data to achieve the operations detailed herein. In various implementations, the processor can transform an element or an article (such as data) from one state or thing to another state or thing. In another example, the activities outlined herein may be implemented with fixed logic or programmable logic (such as software/computer instructions executed by the processor) and the elements identified herein can be some type of a programmable processor (such as a DSP), programmable digital logic (e.g., a FPGA, an erasable programmable read only memory (EPROM), an electrically erasable programmable ROM (EEPROM)), or an ASIC that includes digital logic, software, code, electronic instructions, or any suitable combination thereof.

Some embodiments may be implemented, for example, using a non-transitory computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disc Read Only Memory (CD-ROM), Compact Disc Recordable (CD-R), Compact Disc Rewriteable (CD-RW), optical disk, magnetic media, magneto-optical media, removable memory cards or disks, various types of Digital Versatile Disc (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The various systems and/or components described herein may be implemented in hardware, firmware, software, or a combination thereof. Examples of hardware can include processors, microprocessors, circuits, circuit elements (for example, transistors, resistors, capacitors, inductors, and so forth), integrated circuits, application specific integrated circuits (“ASIC”), programmable logic devices (“PLD”), digital signal processors (“DSP”), field programmable gate arrays (“FPGA”), logic gates, registers, semiconductor devices, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (“API”), instruction sets, computing code, computer code, code segments, computer code segments, words, values, symbols, or any combination thereof.

In various implementations, the various components of the FIGURES can be implemented on a board of an associated electronic device. The board can be a general circuit board that can hold various components of an internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, other considerations, or a combination thereof. Other components, such as external storage, sensors, controllers for audio/video display, and peripheral devices may be attached to the board as plug-in cards, via cables, or integrated into the board itself

In various implementations, the various components of the FIGURES can be implemented as stand-alone modules (for example, a device with associated components and circuitry configured to perform a specific application or function) or implemented as plug-in modules into application specific hardware of electronic devices. Note that particular embodiments of the present disclosure may be readily included in a system-on-chip (SOC) package, either in part, or in whole. An SOC represents an integrated circuit that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the various functions described herein may be implemented in one or more semiconductor cores (such as silicon cores) in application specific integrated circuits (ASICs), field programmable gate arrays (FPGAs), other semiconductor chips, or combinations thereof.

The specifications, dimensions, and relationships outlined herein have only been offered for purposes of example and teaching only. Each of these may be varied considerably without departing from the spirit of the present disclosure, or the scope of the appended claims. The specifications apply only to non-limiting examples and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than a restrictive sense.

Further, the operations and steps described with reference to the preceding FIGURES illustrate only some of the possible scenarios that may be executed by, or within, the various apparatuses, processors, devices, and/or systems, described herein. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Further, note that references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. It is further noted that “coupled to” and “coupled with” are used interchangeably herein, and that references to a feature “coupled to” or “coupled with” another feature include any communicative coupling means, electrical coupling means, mechanical coupling means, other coupling means, or a combination thereof that facilitates the feature functionalities and operations, such as the detection mechanisms, described herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this disclosure in any way that is not otherwise reflected in the appended claims.

### EXAMPLE EMBODIMENT IMPLEMENTATIONS

One particular example implementation may include a system having means for deflecting in response to fluid flow, and means for capacitively measuring deflection of the deflecting means in response to fluid flow. The ‘means for’ in these instances can include (but is not limited to) using any suitable component discussed herein, along with any suitable software, circuitry, hub, computer code, logic, algorithms, hardware, controller, interface, link, bus, communication pathway, etc.

What is claimed is:

1. A capacitive fluid flow sensor for positioning in a path of a fluid flow, the fluid flow sensor comprising:
an airfoil having a flexible surface; and
a capacitive sensor disposed within the airfoil, wherein a capacitance of the capacitive sensor modulates as the flexible surface deflects in response to the fluid flow.

2. The capacitive fluid flow sensor of claim 1, wherein the capacitive sensor includes a movable conductive plate and a fixed conductive plate separated by a dielectric gap, wherein displacement of the movable conductive plate corresponds with deflection of the flexible surface.

3. The capacitive fluid flow sensor of claim 2, wherein the capacitive sensor further includes a printed circuit board having circuitry for measuring a capacitance between the movable conductive plate and the fixed conductive plate.

4. The capacitive fluid flow sensor of claim 3, wherein the fixed conductive plate is a conductive portion of the printed circuit board.

5. The capacitive fluid flow sensor of claim 2, wherein the movable conductive plate is a conductive portion of the flexible surface.

6. The capacitive fluid flow sensor of claim 2, wherein the movable conductive plate is affixed to the flexible surface.

7. The capacitive fluid flow sensor of claim 1, wherein the airfoil includes a living hinge from which the flexible surface extends.

8. The capacitive fluid flow sensor of claim 1, wherein the capacitive sensor includes a capacitance-to-digital converter that measures the capacitance.

9. The capacitive fluid flow sensor of claim 1, further including a temperature sensor affixed to the airfoil, wherein the temperature sensor is configured to detect a temperature of the fluid flow.

10. The capacitive fluid flow sensor of claim 1, wherein the airfoil is secured within a cooled equipment enclosure, and the flexible surface of the airfoil deflects in response to fluid flow within the cooled equipment enclosure.

11. The capacitive fluid flow sensor of claim 1, wherein the airfoil is a single piece of plastic extruded in an airfoil shape with a cavity for insertion of the capacitive sensor.

12. A method for measuring fluid flow, the method comprising:
detecting a change in capacitance when an airfoil surface deflects in response to fluid flow; and
generating a signal that represents the change in capacitance.

13. The method of claim 12, wherein displacement of a movable conductive plate causes the change in capacitance, the displacement of the movable conductive plate corresponding with deflection of the airfoil surface.

14. The method of claim 12, further comprising determining a rate of the fluid flow based on the capacitance change.

15. The method of claim 12, further comprising generating an alarm when the capacitance change meets a fluid flow threshold.

16. The method of claim 12, wherein the airfoil surface deflects in proportion to the fluid flow.

17. The method of claim 12, further comprising:
sensing a temperature of the fluid flow; and
generating a signal that represents the temperature.

18. A thermal management system for an electronics environment, the thermal management system comprising:
means for deflecting in response to airflow within the electronics environment; and
capacitive means for measuring deflection of the deflecting means in response to the airflow.

19. The thermal management system of claim 18, further including means for determining a rate of the airflow based on a capacitance change.

20. The thermal management system of claim 18, further including means for measuring a temperature of the airflow within the electronics environment.
